(19) United States
(12) Patent Application Publication
(10) Pub. No.: US 2006/0091068 A1
(43) Pub. Date: May 4, 2006

(54) Derivatized cellulose filtration media and method for producing same

(76) Inventor: Steven D. Nieland, Waupaca, WI (US)

Correspondence Address: JOSEPH S. HEINO, ESQ.;DAVIS & KUELTHAU, S.C., 111 E. KILBOURN, SUITE 1400, MILWAUKEE, WI, 53202-6613, US

(21) Appl. No.: 11/261,196

(22) Filed: Oct. 28, 2005

Related U.S. Application Data
(60) Provisional application No. 60/623,347, filed on Oct. 29, 2004.

(51) Int. Cl. B01D 39/04

(52) U.S. Cl. 210/503; 210/505; 210/508

(57) ABSTRACT

The base fiber material employed in the manufacture of the filtration media of the present invention includes media of a cellulosic origin. The base fiber material can be mercerized or not. The fiber mixture becomes chemically modified by addition of a selected functionalizing agent.

This application claims the benefit and priority of U.S. Provisional Patent Application No. 60/623,347 filed Oct. 29, 2004.

### FIELD OF THE INVENTION

This invention relates generally to porous medias that are used for filtering contaminants from fluids and to methods for making such medias. More particularly, this invention relates to a functionalized or derivatized cellulose for use as a filtration media that demonstrates improved particle retention, enhanced performance capabilities, selective filtering capabilities, and that is well suited for a variety of uses. It also relates to a method for producing such media.

### BACKGROUND OF THE INVENTION

Early filtration media development was largely designed around the use of naturally occurring fibers such as wool, cellulose, and asbestos and utilized a gradient pore structure to sieve various size contaminants from a filter stream. Gradient pore structure was realized with refined cellulose fiber or cellulose fiber combined with other fibers or various filter aids. Today, wool and cellulose still play an important role in filtration. Natural cellulose can include cotton linters, softwoods, hardwoods, and mercerized cotton linters, and the like.

Electro-statically, natural cellulose is generally negatively charged. However, the amount of alpha versus beta cellulose, ligand content, and other contaminants can affect the charge potential of the overall cellulose matrix. Accordingly, the anionic zeta potential of a given cellulose can range from a few millivolts to about 50 millivolts at typical filtration pH levels. The zeta potential is also related to the dielectric constant of materials. Water, for example, has a dielectric constant near 70 and cellulose has a dielectric constant near 2, which is less than that of water. Accordingly, in water, cellulose has a negative zeta potential. By way of another example, silica has a dielectric constant near 2 and a negative zeta potential in water such that, where cellulose fibers are used to filter silica from water, the charge potential of the fibers and the particles actually causes the fibers to repel the silica instead of attract it. However, by charging the cellulose fibers with a positive zeta potential prior to filtration can provide them with the ability to attract the silica particles.

The role of charge in liquid depth filtration is well known in the art. It is also known that charge modification can allow particles that are significantly smaller than the pores of a given filter media to be captured by charged sites within the media. By incorporating a charged resin with the fibers of a filter brings about an electrostatic enhancement of the fibers. Since most contaminants are anionic at typical filtration pH levels, as alluded to earlier, it is therefore desirable to apply a positive charge to the fibers of the filter media. One method that can be used to accomplish this is to use cationic wet strength resins which increases filtration efficiency by changing the zeta potential of the fibers. However, in a long filtration cycle, or in the case of heavy contamination load, the capacity of charge achieved by the use of such resins can be overwhelmed by the captured particles of contaminant. This condition allows additional particles to pass through the filter once charge sites are consumed. In ordinary filtration, where the particle sizes of the contaminant essentially match the pore sizes of the filter, the filter actually becomes more efficient as it collects particles because the pores progressively grow smaller. In the resin charged filter, where the pore sizes are large so as to allow greater liquid permeability, enhancement is lost when the small contaminant particles coat the pore walls, thus allowing other like particles to pass through the filter. The charge potential imparted by these resins is also relatively low due to a limited number of charge sites that are available from resin cross-linking. Thus, flow rates through the filter must be maintained at a low enough level to stay below the capture velocity of the particle/media combination. If a higher charge potential can be realized, overall filter throughput may be increased.

Many filtration applications target the removal of fine particulate into the submicron range while demanding low pressure drop performance. One typical filtration trade-off is between particle capture efficiency and pressure drop. In many cases, low pressure drop is achieved through the use of coarse fibers, typically 10 micron or greater. As alluded to previously, the fibers can be chemically charged to enhance particle efficiency of small particles. However, on exposure to elevated humidity, temperature, or to certain chemicals, these media lose their effectiveness as a function of time. Attempts have been made to balance the capacity, pressure, and overall life of the filter media through fiber combinations, binder selection, and processing configurations. In U.S. Pat. No. 5,085,784 to Ostreicher, a process of removing particulate contaminants from a fluid is disclosed where the filter media is comprised of cellulose fiber and silica-based particulate together with a charge modified agent of cationic charge modifier. Similarly, U.S. Pat. No. 4,734,208 to Pall et al. discloses a filter media with micro-fibers prepared of glass and cationic thermosetting binder resin of polyamine-epichlorohydrin. In these cases, the combination of materials may yield a filter media with adequate performance but not without some disadvantages. For example, fine particle capture may be limited only to particles that have affinity for the charge of the resin applied. Also, the resins typically used have low charge strength, as mentioned previously. Additionally, effects on the fiber properties from application of the charged resin binders limits their breadth into filtration.

It should also be mentioned that the functionalization of beads used in a chromatography column is well known in the art. However, these columns are expensive, difficult to pack, not robust to a wide range of particle sizes, and provide limited surface area.

Accordingly, what is needed is a functionalized or derivatized cellulose filter media with a higher charge potential and with enhanced particle retention capability. Also needed is such an enhanced cellulose fiber where other functionality can be used to supply specificity in particles removed from the fluid stream. Also needed is a functionalization and derivatization method for producing such enhanced cellulose filter media. Also needed is a functionally modified depth filter media with high filtration efficiencies and life and that can be manufactured cost effectively in a loose form for body feed, formed into filter cakes, or manufactured into sheets that may be used in conventional filter presses, or formed and incorporated into cartridges or other filter devices.

### SUMMARY OF THE INVENTION

The filtration media of the present invention comprises a functionalized or derivatized cellulose fiber filter media with a higher charge potential and with enhanced particle retention capabilities. In the case of charged media, greater charge capacity can be applied to the media. The resulting media possesses higher particle loading relative to other charged materials commonly applied to filtration applications. The charge potential is also increased. By possessing a higher charge potential, larger sized contaminant particles from the fluid stream, or the velocity of the fluid stream may be increased, improving overall throughput.

The filtration media of the present invention also allows other functionalities to be used to supply specificity with respect to particles that are to be removed from the fluid stream. In the filtration media of the present invention, and where conventional media would remove all particles of similar size or charge, specific ions, proteins, or other compounds can be selectively removed from the filter stream while leaving other desirable particles of the same size pass through. This is accomplished by applying the proper functional groups to the cellulose.

The fiber modification method of the present invention also allows for a number of methods in which the fiber can be applied to a final application. Modified fiber can be incorporated in the same forming processes as conventional fibers to produce sheeted media, loose media (for example, cut, ground or milled), or pulp that may later be re-pulped and formed into filter “cakes”. The modification process can also be applied during the formation process or to a formed sheet, allowing modification in situ.

The foregoing and other features of the present invention will be apparent from the detailed description that follows.

### BRIEF DESCRIPTION OF THE DRAWINGS

FIG. 1 is a chart illustrating the relative zeta potentials of various types of cellulose fibers.

FIG. 2 is a cross-sectioned representative view of a charged filter media and showing particles as would be trapped by it.

FIG. 3 is a chart illustrating the relative zeta potentials of various types of cellulose fibers that have been resin coated or derivatized in accordance with the present invention.

FIG. 4 is a chart illustrating reaction results and performance of various filter pad test samples.

FIG. 5 is a photograph illustrating test filter pads correlating increasing dye intensity with increased charge capacity.

### DETAILED DESCRIPTION

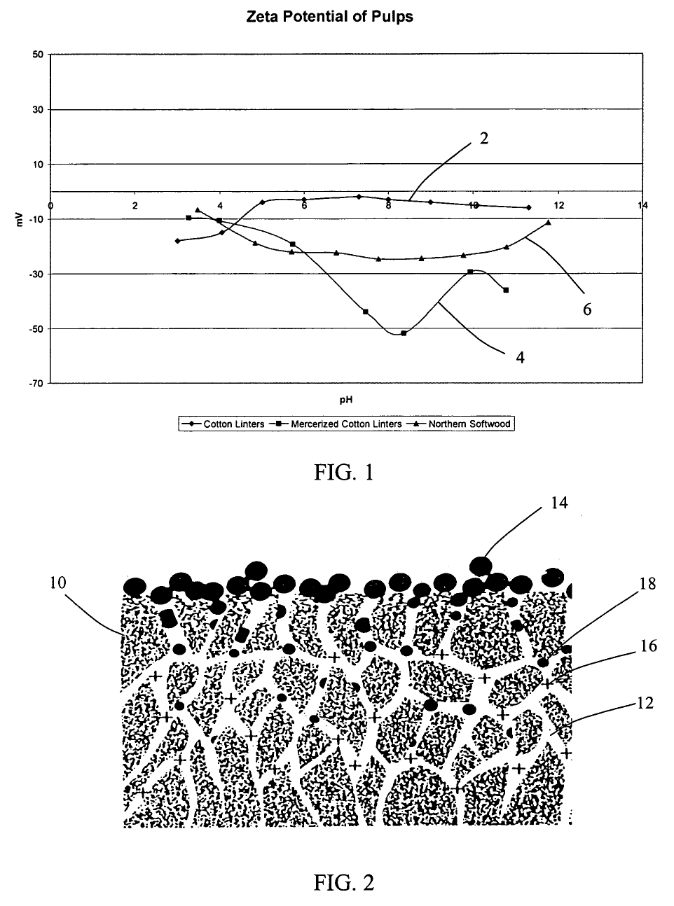

As previously mentioned, natural cellulose is generally negatively charged. However, the amount of alpha versus beta cellulose, ligand content, and other contaminants can affect the charge potential of the overall cellulose matrix. Accordingly, the anionic zeta potential of a given cellulose can range from a few millivolts to about 50 millivolts at typical filtration pH levels. As shown in FIG. 1, the zeta potential of cotton linters 2, mercerized cotton linters 4, and northern softwood 6 is displayed as a function of filtration pH levels present at the filter.

It is well known in the art that charge modification can allow particles that are significantly smaller than the pores of a given filter media to be captured by charged sites within the media. By incorporating a charged resin with the fibers of a filter brings about an electrostatic enhancement of the fibers. Since most contaminants are anionic at typical filtration pH levels, as alluded to earlier, it is therefore desirable to apply a positive charge to the fibers of the filter media. One method that can be used to accomplish this is to use cationic wet strength resins which increases filtration efficiency by changing the zeta potential of the fibers. As shown in FIG. 2, it will be seen that the media 10, which has pores 12 defined in it, is capable of capturing large particles 14 by virtue of pore 12 size and also small particles 18 by virtue of charge 16 applied to the media 10. However, in a long filtration cycle, or in the case of heavy contamination load, the capacity of charge 16 achieved by the use of resins can be overwhelmed by the captured particles 14,18 of contaminant. This condition eventually allows additional particles 18 to pass through the media 10 once charge sites 16 are consumed. In ordinary filtration, where the particle sizes of the contaminant essentially match the pore sizes of the filter, the filter 10 actually becomes more efficient as it collects particles because the pores progressively grow smaller. In the resin charged filter 10, where the pore sizes are large so as to allow greater liquid permeability, enhancement is lost when the small contaminant particles 18 coat the pore 12 walls, thus allowing other like particles 18 to pass through the filter 10. The charge potential 16 imparted by these resins is also relatively low due to a limited number of charge sites that are available from resin cross-linking. Thus, flow rates through the filter 10 must be maintained at a low enough level to stay below the capture velocity of the particle/media combination. If a higher charge potential can be realized, overall filter throughput may be increased.

Reference is now made to the base material utilized in one preferred embodiment, to various examples of the preferred medias constructed in accordance with the method of the present invention, and to tests that the medias were subjected to for the purpose of demonstrating superior performance over medias constructed in accordance with the prior art.

### Base Material

The base material employed in the manufacture of the filtration media of the present invention includes media preferably of a cellulosic origin. Processed cotton is preferred due to higher pure cellulose content, but other cellulose sources, including wood sources, are acceptable.

In the preferred embodiment, the fiber is initially treated utilizing a 1 Normal solution of sodium hydroxide which is mixed with the fiber or passed through the matrix, although other bases can be utilized as well. For example, a solution of potassium hydroxide could also be utilized. The fiber to solution ratio is preferably 100 grams (or “g” hereinafter) of fiber to 625 mL of base. In another embodiment, the cellulose could be modified without the mercerization, but less reactive sites will be exposed resulting in a lower desired activity for the modified material.

The fiber mixture becomes chemically modified by addition of the selected functionalizing agent. Anecdotal evidence suggested that derivatized cellulose may exhibit higher zeta potential than cellulose that is charged using wet strength resins. In the case of positive charge application, an ammonium salt, glycidyl-trimethyl-ammonium chloride (G-MAC) was selected. Being a quaternary ammonium salt, it was believed that it should exhibit favorable cationic charge effects if it could be grafted to the cellulose. This is also reinforced by its use as a base for generating cationic wet strength resins. It was also found that this salt was a good candidate for cellulose derivatization. Preferably, the temperature is elevated to 50° C. to decrease the reaction time, though the reaction can be performed over a wide range of temperatures. Other functionalizing agents using other reaction pathways can be utilized to employ the desired characteristics to the media as well. For example alcohols, thiols, or amines could be added to the mercerized material utilizing a nucleophlic addition; alkenes could be added to the mercerized material utilizing a redox reaction. The agents applied provide selectivity for the contaminants the modified filter material may remove; i.e. thiolsulfonate groups may be effective are removing potassium from wine, a tertiary amine may remove color from syrup, while a chlorinated alkene may be used as an ion exchange component.

The reaction of the cellulose with the G-MAC proceeds in the following manner. After mercerizing the cellulose with NaOH to swell the fiber and increase reactive sites, the epoxide ring is opened in a base-catalyzed reaction utilizing a separate addition of NaOH as follows: 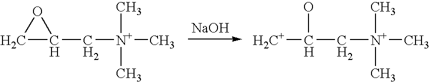
One of the alcohol groups on the cellulose chain is then attacked by the base, removing the hydroxylproton to yield an alkoxide ion as follows: 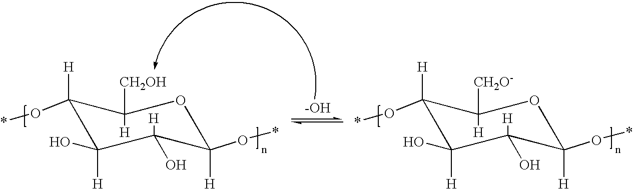
The alkoxide ion then attacks the opened expoxide, with the oxygen from the open ring being protonated later by water as follows: 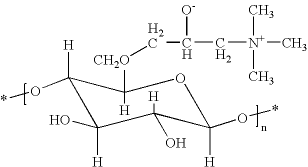
After reacting, the fiber is flushed with water and/or alcohol to remove excess reactants.

### Reaction Results

Stoichiometry

The initial reactions were run at room temperature. Due to the low percentage substitution of G-MAC onto the cellulose, the stoichiometry of the reaction was reviewed. The moles of NaOH available were substantially less than the cellulose or G-MAC.

To improve the reaction efficiency, more base was added while reacting at room temperature, providing about a 12.5% increase in substitution. To further encourage the reaction kinetics, the reaction was conducted again at elevated temperatures. For the three reaction temperatures attempted, the most favorable substitution occurred at 50° C. as shown in Table A:

TABLE A

| | Reactant | | Molecular | |
|---|---|---|---|---|
| | Weight* | | Weight* | Moles |
| Cellulose | 30 | g | 162 g/mol | 0.185 |
| G-MAC | 21.44 | g | 116 g/mol | 0.185 |
| 0.1N NaOH | | | | 0.030 |
| 1N NaOH | | | | 0.500 |

| | Total | | | | | % |
|---|---|---|---|---|---|---|
| | Reacted | | G-MAC | | | Substi- |
| Reaction Conditions | Weight* | | Reacted* | | Moles | tution |
| Cotton, 25° C., 0.1N NaOH | 31.51 | g | 1.51 | g | 0.013 | 6.69% |
| Cotton, 25° C., 1N NaOH | 31.7 | g | 1.7 | g | 0.015 | 7.49% |
| Tyee, 25° C., 1N NaOH | 31.2 | g | 1.2 | g | 0.010 | 5.37% |
| Cotton, 50° C., 1N NaOH | 33.23 | g | 3.23 | g | 0.028 | 13.57% |
| Cotton, 80° C., 1N NaOH | 32.12 | g | 2.12 | g | 0.018 | 9.22% |

*all weights 0% moisture

Charge Potential

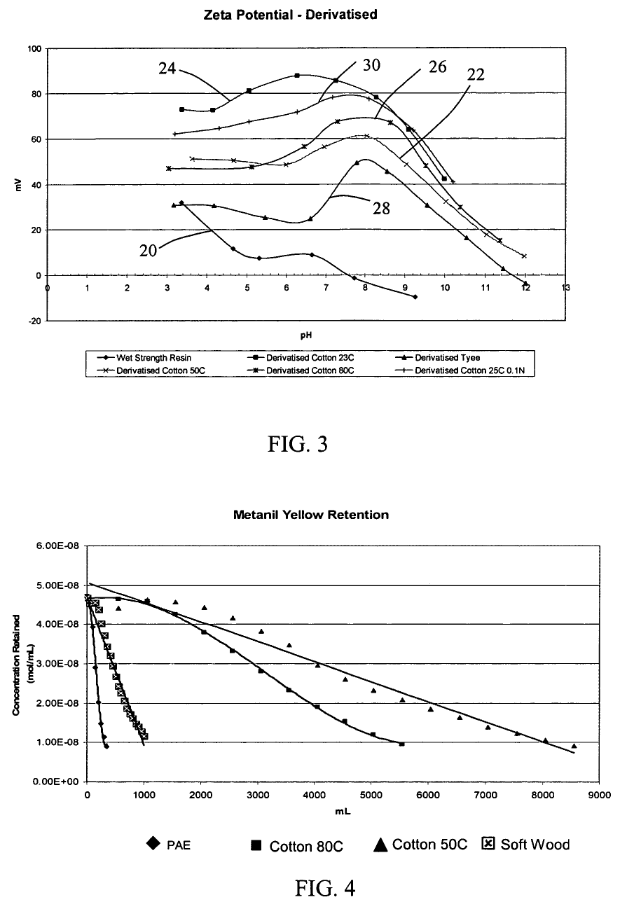

All of the derivatized samples tested exhibited significantly higher charge potential than standard wet strength resin. In addition, all of the derivatized materials also displayed positive charge over a wider pH range. Both of these results are observed in the zeta potential curves shown in FIG. 3 for the modified materials consisting of wet strength resin 20, derivatized cotton 50C 22, derivatized cotton 23C 24, derivatized cotton 80C 26, derivatized tyee 28, and derivatized cotton 25C 0.1 N 30.

Charge Capacity

The charge capacity of the modified materials was measured by filtering a Metanil Yellow dye solution through a fixed weight of media. Metanil Yellow was selected because of its negative charge and small size, on the order of 9 to 18 Ä, too small to be captured. By generating a UV-Vis concentration curve for the dye solution, measuring the absorbance of the challenge solution, and measuring the absorbance of the filtered solution, a curve of the amount of solution filtered versus the concentration retained in the cellulose was obtained. By generating a fit on each of the curves and integrating the area under the curve, the total amount of dye retained could be calculated. As the dye retention on the cellulose is due entirely to the charge, the moles of dye retained correlates directly to the charge capacity of the media.

As shown in FIG. 4, the derivatized material again displayed superior performance over the standard wet strength resin in terms of charge capacity. The total capacity for the cotton reacted at 80° C. was 40 times greater than that of the wet strength resin alone.

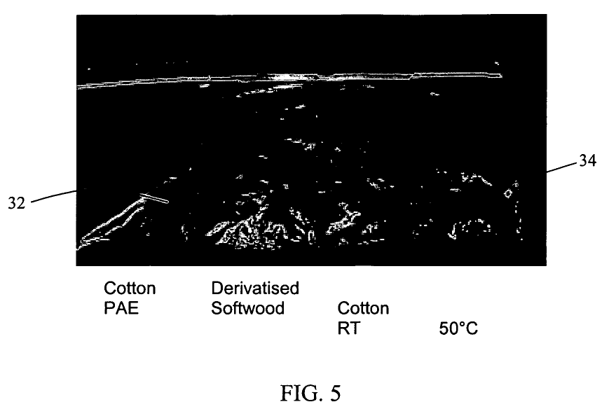

The differences in charge capacity can also be observed visually in the test pads used in the Metanil Yellow filtration. See FIG. 5. As one progresses from left to right in the photograph shown in FIG. 5, one will see that there is an increase in the dye intensity in order from the lowest 32 to the highest 34 charge capacity.

Further Testing

The derivatized material was also tested for its effectiveness in removing color from wine. It is desirable to remove brown color components of oxidation from wine while preserving the red hues. The G-MAC modified material was tested with four other materials commonly used to treat wine by preparing suspensions and treating a control White Zinfandel wine sample with each of the suspensions.

To prepare the filter aid/wine suspension, 2.5 g of filter aid were added to 100 ml of distilled water and circulated for three hours. From this suspension, 2 ml were added to the White Zinfandel by pipette. The samples were then circulated several times over two hours and allowed to sit overnight. The samples were then decanted and filtered through an open cellulose filter to remove the suspended materials. The resulting filtrate was analyzed spectrophotometrically at 420 nm for brown color and at 520 nm for red color. Using this data, the hue and intensity were calculated for each sample. Results are reported in Table B:

TABLE B

| | | | Quanternary | | | |
|---|---|---|---|---|---|---|
| | | | Amine Ion | GMAC | Potassium | polyvinylpoly- |
| | | Potassium | Exchange | Modified | Caseinate/ | pyrrolidone |
| | Control Wine | Caseinate | Resin | Cellulose | PVPP | (PVPP) |
| 420 nm (A) (brown color) | 0.172 | 0.113 | 0.107 | 0.124 | 0.095 | 0.092 |
| Decrease at 420 nm (A) | NA | 34% | 38% | 28% | 45% | 47% |
| 520 nm (A) (red color) | 0.160 | 0.092 | 0.093 | 0.102 | 0.079 | 0.074 |
| Decrease at 520 nm (A) | NA | 43% | 42% | 36% | 51% | 54% |
| Hue | 1.075 | 1.223 | 1.150 | 1.220 | 1.200 | 1.240 |
| Increase in Hue | NA | 13.8% | 7.0% | 13.5% | 11.6% | 15.3% |
| Intensity | 0.332 | 0.205 | 0.2 | 0.226 | 0.174 | 0.166 |
| Decrease in Intensity | NA | 38.3% | 39.8% | 31.9% | 47.6% | 50.0% |

The G-MAC modified cellulose performed favorably in comparison to the other materials tested. While the modified material did not as much of the undesired brown color from the wine, it was found to be significantly better at preserving the red color. The result was a comparable increase in hue and slightly lower decrease in intensity as compared to the other standard treatments.

Based on the foregoing, it has been demonstrated that filtration media produced in accordance with the method of the present invention comprises a functionalized or derivatized cellulose filter media with a higher charge potential and with enhanced particle retention capability. It also comprises an enhanced cellulose fiber where other functionality can be used to supply specificity in particles removed from the fluid stream. The present invention also includes a functionalization and derivatization method for producing such enhanced cellulose filter media. The functionally modified depth filter media with high filtration efficiencies of the present invention can be manufactured cost effectively in a loose form for body feed, formed into filter cakes, or manufactured into sheets that may be used in conventional filter presses or die cut and incorporated into cartridges or other filter devices.

The principles of this invention having been fully explained in connection with the foregoing, I hereby claim as my invention:

1. A chemically-modified cellulose that provides specific functional activity to the cellulose for particle removal, which comprises
a cellulose substrate material, the cellulose substrate material being mercerized with a strong base to provide an increase in potential modification sites, and
at least one functionalizing agent from a desired functional group that is grafted to the cellulose by means of one or more chemical reaction pathways.

2. The chemically-modified cellulose of claim 1 wherein the cellulose substrate material comprises a loose filter media that may be combined with other fibers or filter aids and is supplied in a fibrous format to be dispersed in a fluid to be purified in a fluid filtration application.

3. The chemically-modified cellulose of claim 1 wherein the cellulose substrate material comprises a loose filter media that may be combined with other fibers or filter aids and is supplied as a milled fiber to be dispersed in the fluid to be purified or used to build a cake in a fluid filtration application.

4. The chemically-modified cellulose of claim 1 wherein the cellulose substrate material comprises a sheeted media that may be combined with other fibers or filter aids and is supplied as a pulp sheet that is later re-pulped and formed into cakes for a fluid filtration application.

5. The chemically-modified cellulose of claim 1 wherein the cellulose substrate material comprises a sheeted media that may be combined with other fibers or filter aids and is supplied as a pulp sheet that is later re-pulped and formed into cakes for a fluid filtration application.

6. The chemically-modified cellulose of claim 1 wherein the cellulose substrate material comprises a sheeted media that may be combined with other fibers or filter aids and is supplied as a filter sheet that is utilized in a plate and frame, cartridge, or self contained filter device for a fluid filtration application.

7. The chemically-modified cellulose of claim 1 wherein the cellulose substrate material comprises a formed media that may be combined with other fibers or filter aids and is supplied in a cartridge or self-contained filter device for a fluid filtration application.

8. A chemically-modified cellulose that provides functional specificity to the cellulose for particle removal which comprises
cellulose, and
at least one functionalizing agent from a desired functional group that is grafted to the cellulose by means of one or more chemical reaction pathways.

9. The chemically-modified cellulose of claim 8 wherein the cellulose substrate material comprises a loose filter media that may be combined with other fibers or filter aids and is supplied in a fibrous format to be dispersed in a fluid to be purified in a fluid filtration application.

10. The chemically-modified cellulose of claim 8 wherein the cellulose substrate material comprises a loose filter media that may be combined with other fibers or filter aids and is supplied as a milled fiber to be dispersed in the fluid to be purified or used to build a cake in a fluid filtration application.

11. The chemically-modified cellulose of claim 8 wherein the cellulose substrate material comprises a sheeted media that may be combined with other fibers or filter aids and is supplied as a pulp sheet that is later re-pulped and formed into cakes for a fluid filtration application.

12. The chemically-modified cellulose of claim 8 wherein the cellulose substrate material comprises a sheeted media that may be combined with other fibers or filter aids and is supplied as a pulp sheet that is later re-pulped and formed into cakes for a fluid filtration application.

13. The chemically-modified cellulose of claim 8 wherein the cellulose substrate material comprises a sheeted media that may be combined with other fibers or filter aids and is supplied as a filter sheet that is utilized in a plate and frame, cartridge, or self contained filter device for a fluid filtration application.

14. The chemically-modified cellulose of claim 8 wherein the cellulose substrate material comprises a formed media that may be combined with other fibers or filter aids and is supplied in a cartridge or self-contained filter device for a fluid filtration application.

15. A method for chemically-modifying cellulose to provide specific functional activity to the cellulose for particle removal, which comprises the steps of
providing a cellulose substrate material,
using a strong base to mercerize the cellulose substrate material to provide an increase in potential modification sites, and
grafting at least one functionalizing agent from a desired functional group to the cellulose by means of one or more chemical reaction pathways.

16. The method of claim 15 wherein the cellulose substrate material providing step comprises providing a loose filter media that may be combined with other fibers or filter aids and is supplied in a fibrous format to be dispersed in a fluid to be purified in a fluid filtration application.

17. The method of claim 15 wherein the cellulose substrate material providing step comprises providing a loose filter media that may be combined with other fibers or filter aids and is supplied as a milled fiber to be dispersed in the fluid to be purified or used to build a cake in a fluid filtration application.

18. The method of claim 15 wherein the cellulose substrate material providing step comprises providing a sheeted media that may be combined with other fibers or filter aids and is supplied as a pulp sheet that is later re-pulped and formed into cakes for a fluid filtration application.

19. The method of claim 15 wherein the cellulose substrate material providing step comprises providing a sheeted media that may be combined with other fibers or filter aids and is supplied as a pulp sheet that is later re-pulped and formed into cakes for a fluid filtration application.

20. The method of claim 15 wherein the cellulose substrate material providing step comprises providing a sheeted media that may be combined with other fibers or filter aids and is supplied as a filter sheet that is utilized in a plate and frame, cartridge, or self contained filter device for a fluid filtration application.

21. The method of claim 15 wherein the cellulose substrate material providing step comprises providing a formed media that may be combined with other fibers or filter aids and is supplied in a cartridge or self-contained filter device for a fluid filtration application.

22. A method for chemically-modifying cellulose to provide functional specificity to the cellulose for particle removal which comprises the steps of
providing cellulose, and
grafting at least one functionalizing agent from a desired functional group to the cellulose by means of one or more chemical reaction pathways.

23. The method of claim 22 wherein the cellulose providing step comprises providing a loose filter media that may be combined with other fibers or filter aids and is supplied in a fibrous format to be dispersed in a fluid to be purified in a fluid filtration application.

24. The method of claim 22 wherein the cellulose providing step comprises providing a loose filter media that may be combined with other fibers or filter aids and is supplied as a milled fiber to be dispersed in the fluid to be purified or used to build a cake in a fluid filtration application.

25. The method of claim 22 wherein the cellulose providing step comprises providing a sheeted media that may be combined with other fibers or filter aids and is supplied as a pulp sheet that is later re-pulped and formed into cakes for a fluid filtration application.

26. The method of claim 22 wherein the cellulose providing step comprises providing a sheeted media that may be combined with other fibers or filter aids and is supplied as a pulp sheet that is later re-pulped and formed into cakes for a fluid filtration application.

27. The method of claim 22 wherein the cellulose providing step comprises providing a sheeted media that may be combined with other fibers or filter aids and is supplied as a filter sheet that is utilized in a plate and frame, cartridge, or self contained filter device for a fluid filtration application.

28. The method of claim 22 wherein the cellulose providing step comprises providing a formed media that may be combined with other fibers or filter aids and is supplied in a cartridge or self-contained filter device for a fluid filtration application.
